(19) United States
(12) Patent Application Publication
(10) Pub. No.: US 2011/0036881 A1
(43) Pub. Date: Feb. 17, 2011

(54) GOLF CART STORAGE ACCESSORY

(75) Inventor: William G. Higgs, Waxhaw, NC (US)

Correspondence Address: ADAMS INTELLECTUAL PROPERTY LAW, Suite 2350 Charlotte Plaza, 201 South College Street, CHARLOTTE, NC, 28244, US

(73) Assignee: Mustang Motion LLC, Waxhaw, NC (US)

(21) Appl. No.: 12/540,684

(22) Filed: Aug. 13, 2009

(51) Int. Cl. B60R 7/04; B60R 11/00

(52) U.S. Cl. 224/274; 224/542

(57) ABSTRACT

A golf cart storage accessory including a storage tray defining a support surface and opposing sidewalls and end walls extending upwardly from the support surface, and mounting structure attached to the storage tray having a shape corresponding to the shape of at least one golf ball, the mounting structure being configured to engage a conventional golf ball holder of a golf cart.

### TECHNICAL FIELD AND BACKGROUND OF THE INVENTION

1. Field of the Invention

The present invention relates generally to the field of golf cart accessories, and more particularly, to storage trays for holding golf-related and other items configured to mount within an existing golf ball holder of a conventional golf cart.

2. Background of the Invention

Conventional golf carts typically include compartments for storing a variety of golf-related and personal items including, but not limited to, golf balls, tees, beverages, snacks, towels and personal telecommunications devices. These storage compartments are typically located within the dashboard of the golf cart, such as molded into the dashboard structure. Certain storage compartments are purposely designed to hold specific items in a secure manner, such as golf balls, tees and beverages. Other storage compartments are often larger, undefined compartments in which items are loosely maintained and often shift along with cart movement, potentially causing damage to fragile items.

Like most other sports and activities, technology has infiltrated various aspects of the game of golf. Specifically, and pertaining to the present invention, GPS units and rangefinders are now commonly used to provide course information that in the past was obtained through fairway markers and experience. This new access to information includes precise yardage information from any location, hole layouts and hazard locations, among other information. These electronic devices are also often configured to store player information and connect to data storage programs through communications networks.

Various apparatus have been developed to store these electronic devices in a golf cart in a secure and readily accessible manner, while allowing the golfer to view the device's display when stored. Typical examples include a cradle designed to releasably engage the device, a flexible arm member for selectively positioning the cradle, and a supportive base for anchoring the device to the golf cart. One particular example includes an anchor defining a cup holder-shaped base that occupies an existing cup holder. Another particular example includes an anchor having a clamping member that attaches to the cart, such as to an upright frame member of the cart canopy. While these apparatus are specifically designed to hold certain devices, they disadvantageously are not universal in application and thus cannot accommodate all types of devices. Specifically, ocular devices and personal telecommunications devices either do not lend themselves to being supported within a cradle or require a specific cradle design not envisioned by a golf cart accessory manufacturer.

Accordingly, it would be desirable to provide a golf cart accessory for storing a wide variety of types of relatively small, fragile items, such as ocular and electronic devices, in a secure and readily accessible manner. It would further be desirable to provide a golf cart storage accessory that utilizes existing golf cart structure for mounting, and mounts without the need for tools or elaborate structure. The accessory should be durable and low cost to manufacture.

### BRIEF SUMMARY OF THE INVENTION

To achieve the foregoing and other advantages, various embodiments of a golf cart storage accessory are described herein that mount to existing golf cart structure. In one embodiment, the golf cart storage accessory includes a storage tray defining a support surface and opposing sidewalls and end walls extending upwardly from the support surface, and mounting structure attached to the storage tray having a shape corresponding to the shape of at least one golf ball, wherein the mounting structure is configured to engage an existing golf ball holder of a conventional golf cart.

In another embodiment, the mounting structure defines a shape corresponding to the shape of at least two golf balls arranged in a side-by-side manner, with each golf ball shaped mounting structure being attached to both the storage tray and to one another.

In a further embodiment, the mounting structure defines a shape corresponding to the shape of three golf balls arranged in a side-by-side manner, with each golf ball shaped mounting structure being attached to both the storage tray and to one another.

In a further embodiment, the golf cart storage accessory further includes non-skid material defined by or positioned upon the support surface.

In a further embodiment, the mounting structure is attached to the bottom of the support surface in order to mount the storage accessory to a generally horizontally positioned golf ball holder of the golf cart.

In a further embodiment, the mounting structure is attached to an exterior surface of one of the opposing sidewalls and end walls in order to mount the storage accessory to a generally vertically positioned golf ball holder of the golf cart.

In a further embodiment, the golf cart storage accessory includes one of a spacer and an articulating arm positioned intermediate the storage tray and the mounting structure to provide distance between the two to accommodate any existing golf ball holder and position the tray generally horizontally.

In a further embodiment, a golf cart storage accessory is provided including a storage tray defining a support surface and opposing sidewalls and end walls extending upwardly from the support surface, and mounting structure attached to the storage tray configured to engage an existing golf ball holder of a golf cart.

Additional features of the invention will be set forth in the detailed description which follows, and in part will be readily apparent to those skilled in the art from that description or recognized by practicing the invention as described herein.

### BRIEF DESCRIPTION OF THE FIGURES

These and other features, aspects and advantages of the present invention are better understood when the following detailed description of the invention is read with reference to the accompanying drawings, in which:

FIG. 1 is a perspective view of a golf cart storage accessory in accordance with an embodiment of the present invention;

FIG. 2 is a bottom plan view of the cart accessory shown in FIG. 1 illustrating the mounting structure;

FIG. 3 is a side view of the cart accessory shown in FIG. 1 illustrating the interface between the storage tray and mounting structure;

FIG. 4 is a passenger's perspective view of a conventional golf cart dashboard including a generally horizontally positioned golf ball holder for mounting the accessory of FIG. 1;

FIG. 5 is an alternative embodiment of a golf cart storage accessory including an articulating arm positioned intermediate the tray and mounting structure; and

FIG. 6 is an alternative embodiment of a golf cart storage accessory including side-mounted mounting structure for engaging a vertically positioned golf ball holder.

### DETAILED DESCRIPTION OF THE INVENTION

The present invention will now be described more fully hereinafter with reference to the accompanying drawing in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention.

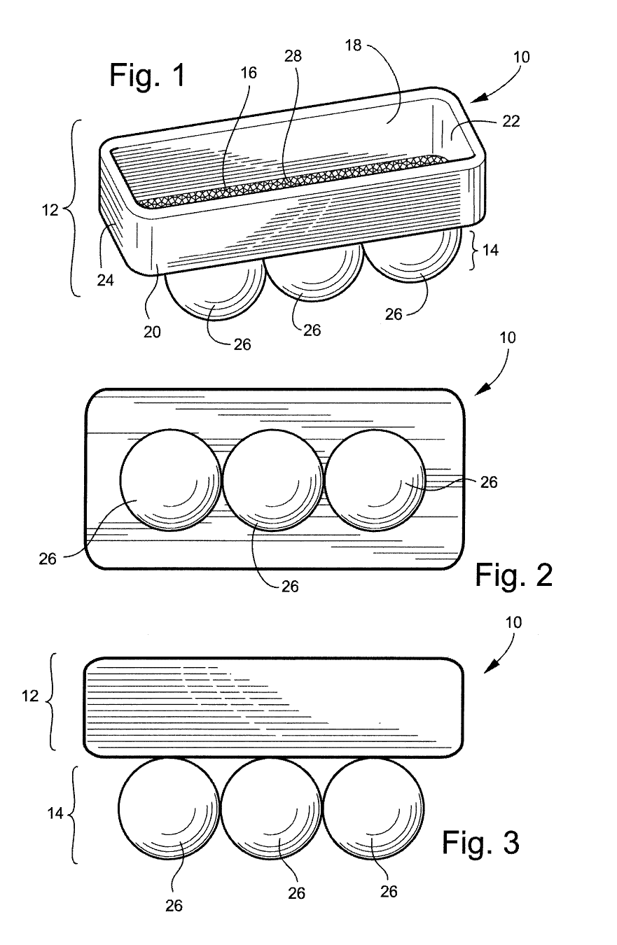

Referring to FIGS. 1-3, a golf cart storage accessory in accordance with a preferred embodiment of the invention is illustrated generally at reference numeral 10. The storage accessory 10 includes a support tray 12 and attached mounting structure 14. In one embodiment, the support tray 12 and mounting structure 14 are integrally formed. The support tray 12 includes a base 16, also referred to herein as a “tray bottom”, for supporting at least one item thereon. Opposing sidewalls 18, 20 and opposing end walls 22, 24 extend upwardly from the base 16 a predetermined height. As shown, the support tray 12 is generally rectangular-shaped and defines an open top. It is envisioned that the support tray 12 may have any length, width and height, or any other desired shape without departing from the scope of the invention. The height of the opposing sidewalls 18, 20 and end walls 22, 24 may vary depending upon the types of items envisioned to be stored. As shown, the support tray 12 includes generally rounded corners. Although not shown, the storage accessory 10 may optionally include a removable and/or pivoting top. Although not shown, the interior compartment defined by the support tray 12 may be divided into a plurality of compartment and/or include custom structure for holding specific items.

Attached to the bottom surface of the base 16 is the mounting structure 14. The mounting structure 14 includes at least one mounting member 26 having a shape corresponding to that of a conventional golf ball so as to mount through an interference fit within an existing golf ball holder of a golf cart, as described in detail below. As shown, the mounting structure 14 includes three golf ball-shaped members 26 arranged in a side-by-side manner. The mounting structure 14 is generally centered with respect to the support tray 12. The members 26 are interconnected and each member 26 is attached to the underside of the support tray 12 to provide strength against upward pulling forces on the accessory 10 when removing it from the golf cart. Although three members 26 are shown, one member 26 may be adequate to mount the accessory 10 to the golf cart, however, at least two members 26 are preferred to prevent rotation about the lateral axis of the accessory 10 when installed. Although the mounting members 26 are shown to have a generally smooth contour, the members 26 may include dimpling or other pattern for an aesthetic effect and/or enhance the interference fit with the golf ball holder.

Referring specifically to FIG. 1, the base 16 includes a non-skid material 28 positioned thereon for increasing the coefficient of friction. Suitable non-skid materials include, but are not limited to, non-skid tapes, coatings, and padding that may or may not be applied with an adhesive. The non-skid materials are preferably resistant to water. The non-skid material, as well as other components of the accessory 10, may include graphics or other indicia printed thereon for customization or advertising purposes.

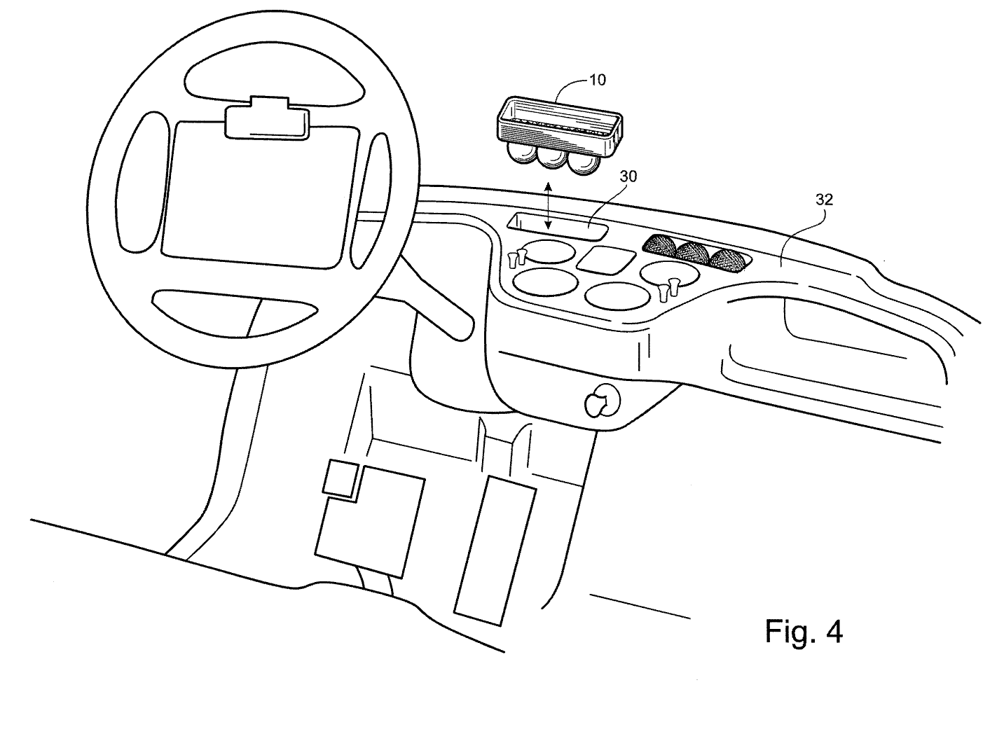

Referring to FIG. 4, one example of a portion of a conventional golf cart is shown including a golf ball holder 30 molded into the dashboard 32. Two golf ball holders 30 are shown, one occupied with a plurality of golf balls and the other ready to receive the accessories described herein. The golf ball holder 30 as shown defines an elongate channel having any length and a width corresponding to that of about a golf ball, preferably just slightly larger to accept the balls therein. In a specific embodiment, the width defines a narrowing lip that must be overcome by slight force to enter/exit the holder 30 to retain the balls and accessories.

When installed, the bottom surface of the support tray 12 sits generally flush against the dashboard such that rotation about the longitudinal axis of the accessory 10 is prevented and the support tray 12 maintains a generally horizontal position to prevent items from falling out. The accessory 10 is installed without the needs for tools or altering the existing golf ball holder. A user simply applies a downward force, such as applied though grabbing the support tray 12, to engage the mounting structure 14 and ball holder 30. The accessory 10 is removed by pulling up on the tray 12. It is envisioned that the accessory 10 may be modified to engage other golf ball holders, for example, by providing space between adjacent mounting members 26 to engage individual ball holders.

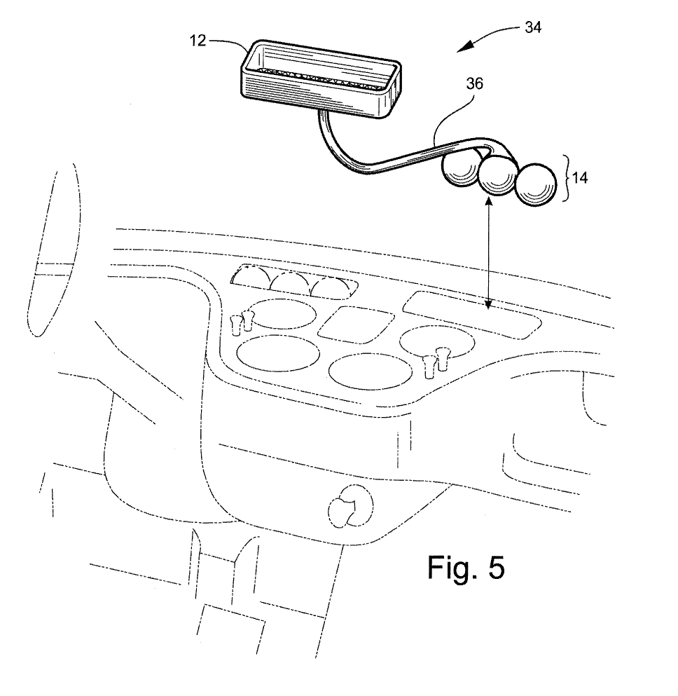

Referring to FIG. 5, an alternative embodiment of a golf cart storage accessory is illustrated generally at reference numeral 34. The accessory 34 further includes a spacer 36 positioned intermediate the support tray 12 and mounting structure 14. As shown, the spacer 36 is an articulating arm configured to alter the position of the support tray 12 relative to the mounting structure 14. In certain applications, it may be necessary to allow adjustment of the support tray 12 to position the tray generally horizontal, such as in installations in which the golf ball holder is not located within a generally horizontal surface of the golf cart. The spacer 36 may have any length, and in embodiments in which the spacer is articulating, is capable of maintaining its shape. The spacer 36 is preferably additionally configured to rotate the support tray 36 relative to the mounting structure 14.

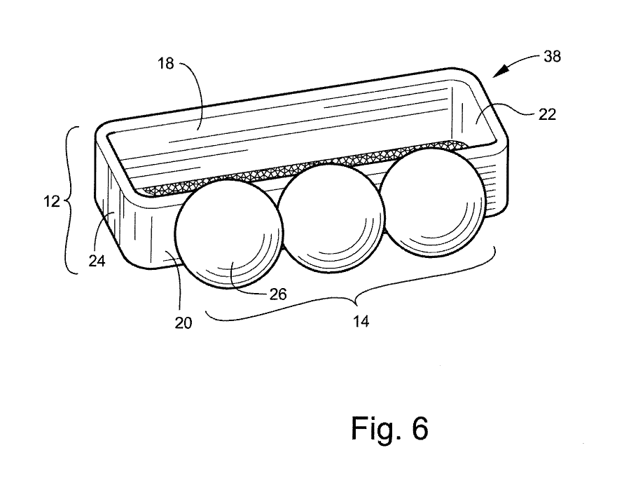

Referring to FIG. 6, another alternative embodiment of a golf cart storage accessory is illustrated generally at reference numeral 38. The accessory 38 includes an alternative arrangement of the components in which the mounting structure 14 is attached to the outer surface of the one of the opposing sidewalls 18, 20 and end walls 22, 24 to accommodate generally vertical surface installation. Thus, when installed, the support tray 12 extends laterally from the vertical surface.

The accessories 10, 34 and 38 described herein may be constructed from any types of materials. Preferable materials include plastics and like materials that are durable, UV resistant and water resistant. In a specific example the mounting structure 14 has a texture and durometer about equal to that of a conventional golf ball.

While various embodiments of a golf cart accessory have been described with reference to specific embodiments and examples, it is envisioned that various details of the invention may be changed without departing from the scope of the invention. Furthermore, the foregoing description of the preferred embodiments of the invention and best mode for practicing the invention are provided for the purpose of illustration only and not for the purpose of limitation.

What is claimed is:

1. A golf cart storage accessory, comprising:
a storage tray defining a support surface and opposing sidewalls and end walls extending upwardly from the support surface; and
mounting structure attached to the storage tray having a shape corresponding to the shape of at least one golf ball, the mounting structure being configured to engage a golf ball holder of a golf cart.

2. The golf cart storage accessory according to claim 1, wherein the mounting structure has a shape corresponding to the shape of at least two golf balls arranged in a side-by-side manner with each golf ball shaped mounting structure being attached to both the storage tray and to one another.

3. The golf cart storage accessory according to claim 3, wherein the mounting structure has a shape corresponding to the shape of three golf balls arranged in a side-by-side manner with each golf ball shaped mounting structure being attached to both the storage tray and to one another.

4. The golf cart storage accessory according to claim 1, further comprising a non-skid material positioned upon the support surface.

5. The golf cart storage accessory according to claim 1, wherein the mounting structure is attached to the bottom of the support surface.

6. The golf cart storage accessory according to claim 1, wherein the mounting structure is attached to an exterior surface of one of the opposing sidewalls and end walls.

7. The golf cart storage accessory according to claim 1, further comprising a spacer positioned intermediate the storage tray and the mounting structure.

8. The golf cart storage accessory according to claim 1, further comprising an articulating arm positioned intermediate the storage tray and the mounting structure.

9. A golf cart storage accessory, comprising:
a storage tray defining a support surface and opposing sidewalls and end walls extending upwardly from the support surface; and
mounting structure attached to the storage tray configured to engage a golf ball holder of a golf cart.

10. The golf cart storage accessory according to claim 9, wherein the mounting structure defines a shape corresponding to the size and shape of a golf ball.

11. The golf cart storage accessory according to claim 9, wherein the mounting structure defines a shape corresponding to the size and shape of at least two golf balls arranged in a side-by-side manner with each golf ball shaped mounting structure being attached to both the storage tray and to one another.

12. The golf cart storage accessory according to claim 9, further comprising a non-skid material positioned upon the support surface.

13. The golf cart storage accessory according to claim 9, wherein the mounting structure is attached to the bottom of the support surface.

14. The golf cart storage accessory according to claim 9, wherein the mounting structure is attached to an exterior surface of one of the opposing sidewalls and end walls.

15. The golf cart storage accessory according to claim 9, further comprising a spacer positioned intermediate the storage tray and the mounting structure.

16. The golf cart storage accessory according to claim 9, further comprising an articulating arm positioned intermediate the storage tray and the mounting structure.
